(19) United States
(12) Patent Application Publication
(10) Pub. No.: US 2026/0156730 A1
(43) Pub. Date: Jun. 4, 2026

(54) THERMAL IMAGED COLOR-ADAPTIVE SPOT LIGHTING

(71) Applicant: Autosystems, a division of Magna Exteriors Inc., Aurora (CA)

(72) Inventors: Adam L. Bushre, Saranac, MI (US); Adam S. McCain, Grandville, MI (US)

(21) Appl. No.: 19/395,955

(22) Filed: Nov. 20, 2025

Related U.S. Application Data
(60) Provisional application No. 63/727,733, filed on Dec. 4, 2024.

(51) Int. Cl. H05B 47/125; B60Q 1/14; H05B 47/13

(52) U.S. Cl. CPC H05B 47/125; B60Q 1/143; H05B 47/13; B60Q 2300/45

(57) ABSTRACT

A lighting system for a vehicle includes a sensor that is configured to detect at least one characteristic of an environment to be illuminated by the lighting system. The lighting system also includes a light assembly that is configured to illuminate the environment. The lighting system is configured to adjust a light output of the light assembly based on the at least one characteristic of the environment to enhance a visible luminance of the environment.

### CROSS REFERENCE TO RELATED APPLICATIONS

This U.S. utility patent application claims the benefit of U.S. Provisional Patent Application No. 63/727,733 filed Dec. 4, 2024, the contents of which is incorporated herein by reference in its entirety.

### FIELD

The present disclosure relates generally to lighting for motor vehicles. More specifically, the present disclosure relates to lighting for passenger vehicles, such as cars and trucks and which is adaptive based on a sensed characteristic to enhance visibility of the environment.

### BACKGROUND

A vehicle may be equipped with one or more sensors, such as cameras and/or thermal sensors for detecting objects or living beings. A vehicle may also be equipped with a lighting system to illuminate the environment. However, conventional solutions may not adjust a light output of the lighting system based on a sensed characteristic to enhance visible luminance.

### SUMMARY

The present disclosure provides a lighting system for a vehicle. The lighting system includes a sensor that is configured to detect at least one characteristic of an environment to be illuminated by the lighting system. The lighting system also includes a light assembly that is configured to illuminate the environment. The lighting system is configured to adjust a light output of the light assembly based on the at least one characteristic of the environment to enhance a visible luminance of the environment.

The present disclosure also provides a method for operating a lighting system of a vehicle. The method includes: detecting, by a sensor, at least one characteristic of an environment to be illuminated by the lighting system; illuminating, by a light assembly, the environment; and adjusting a light output of the light assembly based on the at least one characteristic of the environment and to enhance a visible luminance of the environment.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a perspective view of a vehicle with a vision system that incorporates a camera and low resolution thermal sensor in accordance with an aspect of the present disclosure;

FIG. 2 shows a schematic block diagram of a vehicle with a lighting system, in accordance with an aspect of the present disclosure; and

FIG. 3 shows a flow chart listing steps in a method for operating a lighting system for a vehicle, in accordance with an aspect of the present disclosure.

### DETAILED DESCRIPTION

Referring to the drawings, the present invention will be described in detail in view of following embodiments.

It is an objective of the invention of the present disclosure to provide a lighting system for a vehicle and method of operating a lighting system for a vehicle that is configured to detect and to modify an illumination in order to enhance visibility of an object or living being, such as a pedestrian, a cyclist, or an animal. The term “object/being” is used herein to reference any object, entity, or living being to be detected and illuminated by the system and method of the present disclosure. The system and method of the present disclosure may detect an object/being at night and direct a spot light toward the object/being in order to illuminate the object/being and/or a zone surrounding the object/being. Thus, the lighting system and method of the present disclosure may improve visibility of object/being in the path of the vehicle, helping a driver to more easily and quickly see the object/being, and thereby improving safety.

A sensor may detect characteristics of environment, such as thermal or reflectance characteristics of the object/being, and adjust the spotlight light output. For example, the system and method of the present disclosure may change a temperature or color output of existing lighting in order to enhance visibility of the detected object/being. In one example, light output may be adjusted to have similar luminance of different road surfaces. The lighting system of the present disclosure may adjust light output to provide maximal reflectance of light off of an object/being. For example, the lighting system may select a color spectrum that has a least absorption by the object or living being. The lighting system and method of the present disclosure, can, thereby provide enhance localized illumination of the ground upon which the object/being is located or traveling, and/or provide enhanced illumination of the object/being itself by ensuring a maximal amount of light is reflected therefrom.

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

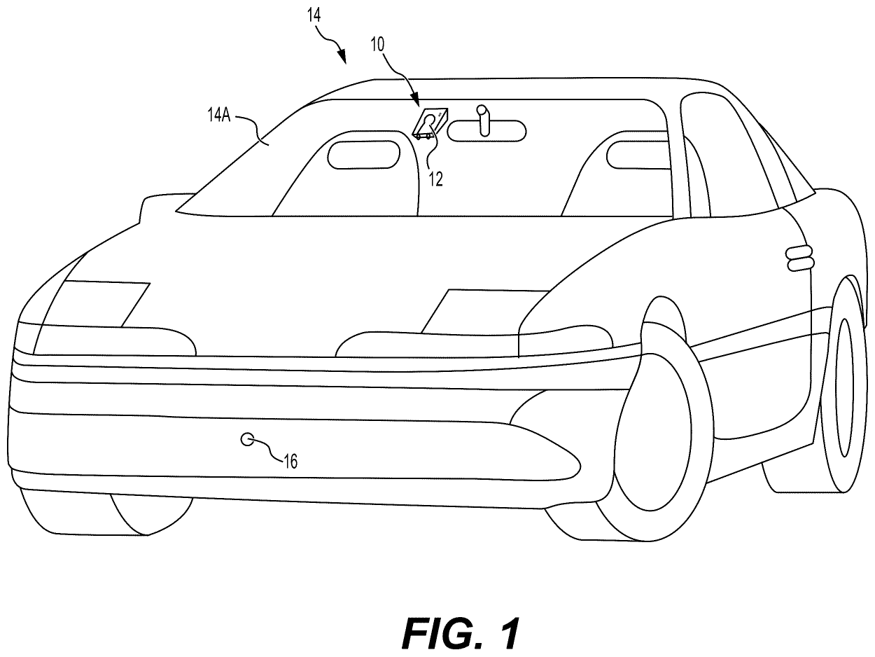

Referring now to the drawings and the illustrative embodiments depicted therein, a vehicular camera system or vision system 10 has a forward viewing camera 12 that can be installed on the inside of the front windshield 14a of a vehicle 14, such as a car, truck, bus, or van (FIG. 1). Such a camera system may be used for a variety of functions such as object detection, lane keeping, and high beam control. As shown in FIG. 1, the vehicular camera system or module is configured to be attached in a front-facing manner to the vehicle 14 so as to have a field of view through the windshield and forward of the vehicle. The vision system 10 includes or is associated with a thermal sensor 16, which is disposed at a forward portion of the vehicle, such as at the vehicle bumper or the like) and views forwardly of the vehicle to determine the presence of “hot spots” ahead of the vehicle. The vision system includes a controller having a processor that processes an output of the low resolution thermal sensor to determine if there are hot spots ahead of the vehicle that may be indicative of a pedestrian or animal ahead of the vehicle. Responsive to a determination of such a hot spot, the system may control a forward facing light of the vehicle (such as a headlight or spot light of the vehicle) to illuminate the determined hot spot area, whereby the processor processes image data captured by the forward viewing (higher resolution) camera 12 (such as a black and white camera or monochrome camera or a color camera) to determine if the detected hot spot is indicative of a pedestrian or animal or the like ahead of the vehicle. Responsive to such a determination, the system may generate an alert to the driver (such as a visual or audible alert or haptic alert or the like) or may control a braking system or steering system of the vehicle to avoid impact with the determined pedestrian or animal.

Optionally, the camera may be associated with a multi-camera vision system of the vehicle, and the forward viewing camera and multiple exterior viewing cameras (such as a rearward facing camera at the rear of the vehicle, and a sideward/rearward facing camera at respective sides of the vehicle) may capture image data of the regions exterior of the vehicle, with the camera having a lens for focusing images at or onto an imaging array or imaging plane or imager of the camera. The vision system includes a control or electronic control unit (ECU) or processor that is operable to process image data captured by the cameras and may provide displayed images at a display device for viewing by the driver of the vehicle. The data transfer or signal communication from the camera to the ECU may comprise any suitable data or communication link, such as a vehicle network bus or the like of the equipped vehicle.

In some applications of vehicle vision systems, such as for pedestrian detection or the like, it may be desirable to include a high resolution thermal imager to provide enhanced night vision detection of pedestrians and animals. Such “Focus Beam” systems typically are very costly since they use high resolution thermal imagers for the whole night vision detection of pedestrians and animals.

The vision system of the present disclosure uses the longer range of a thermal sensor 16 to find suspected “hot spots” (regions in the field of view of the sensor where there is a determined concentrated area or object that has an elevated temperature above a threshold level) that can potentially be pedestrians or animals and then directs “spotlighting head-lights” towards the determined hotspot and uses a standard high resolution CMOS imager to detect the full characteristics of the actual object. The thermal sensor 16 may be a low-resolution device having a resolution that is substantially less than a resolution of the forward viewing camera 12. Additionally or alternatively, a “hot spot” may include regions in the field of view of the sensor where there is Lidar or Radar echo, Flash Ladar time of flight (TOF) image slice or short wave infrared (SWIR) night sky glare on an object or the like. The hot spot thus is determined by detecting a region within the field of sensing of the low resolution sensor where there exists a concentration of electromagnetic radiation above a threshold level. For example, the low resolution sensor may determine a hot spot where it senses a region where a light level or heat level or infrared radiation level is above a threshold level.

Thermal sensors (typically bolometer based) are inherently very costly, but costs come down significantly with lower resolution (such as, for example, a thermal sensor having a sensing array of only about 80×30 pixels or thereabouts) since the yield goes up exponentially and the amount of Silicon for the read out circuits and expensive materials and the related processing of the thermal sensors is reduced (more dies per wafer). Additionally, the expensive optics (usually Germanium lenses) are reduced in size (due to the smaller low resolution sensing array) and with that the costs and mounting space requirements are also reduced.

Also, because thermal sensors have to be mounted in the front area (such as the bumper) of the vehicle (such thermal sensors cannot sense through the glass windshield), they are likely to have to be replaced, at high cost for the owner/insurance company, for even small frontal accidents or impacts.

The thermal sensor of the vision system of the present disclosure may include a low resolution sensor having a low resolution array of pixels (such as less than or equal to about 480 pixels, or less than or equal to about 240 pixels or thereabouts or less than or equal to about 100 pixels or thereabouts). The thermal sensor may be sensitive to far infrared (FIR) wavelengths, such as between about 6 and 12 microns.

In order to positively and reliably detect, for example, a pedestrian, it is useful to have about 10 to 20 pixels (such as a sub-array of about 4×4 pixels or the like) of the sensor viewing or having the field of view on the object. In order to do this at a distance further ahead of the vehicle than is illuminated by the low beam lighting of the vehicle, such as greater than about 60 meters or thereabouts, a fairly high resolution is needed from the thermal imaging system, and this is what is so cost prohibitive.

By limiting the detection (by the low resolution thermal sensor) to just a “hotspot” without further detection or determination of the object, only a few pixels will be necessary to make the initial determination. Once the hot spot has been identified, a visible light (or near infrared (NIR) or infrared (IR) light) focused light beam is targeted at the hot spot (or general region where the hot spot is detected) for further or enhanced image processing of image data captured by the forward viewing higher resolution camera for further characterization of the type of object and possibly its predicted path (and likelihood that the object may become a danger to the driven vehicle or may become endangered by the driven vehicle).

The system may then generate a warning (audio/visual/haptic) depending on the outcome of the detection and determination of the object and the predicted path of the vehicle and the determined object.

The present disclosure thus provides a vehicle vision system having a forward viewing camera (such as at the windshield of the vehicle) and a low resolution thermal sensor (such as at the vehicle bumper or the like). The system processes outputs of the low resolution thermal sensor to determine hot spots ahead of the vehicle and, responsive to such a hot spot being determined, controls a light of the vehicle to direct illumination towards the determined hot spot area, whereby processing of image data captured by the higher resolution forward viewing camera further determines what the determined hot spot is and whether or not its presence is a hazardous condition. For example, the system may control the vehicle headlights to direct greater illumination towards the determined hot spot area, such as by switching the headlights to a high beam mode or by controlling a direction of the principal axis of the beams of light emitted by the headlights. When sufficient illumination is at the determined hot spot area, image processing of image data captured by the higher resolution forward viewing camera further determines or characterizes or identifies the hot spot area to determine if it is representative of a pedestrian or animal or the like that may be in or moving into the path of the vehicle.

Optionally, the low resolution sensor may comprise a sensor that operates or is sensitive in the short wave infrared (SWIR) spectrum range (such as between about 1 and 1.8 micron wavelength), and thus can pick up useful night glare from the sky to determine the presence of objects before a CMOS camera can detect the objects. Optionally, the low resolution sensor may comprise a sensor that is sensitive in the mid-infrared (MIR) spectral band or wavelengths (such as between about 2 and 6 microns wavelength).

The low resolution sensor may also comprise different sensor technology (more expensive per pixel/data point), such as, for example, a FLASH Ladar or Lidar or the like. The system of the present disclosure may apply the same principle for a low quality low resolution Radar (such as to provide early detection of “hotspots”) that could include vulnerable road users and animals (VRUs). This would also mean that the “low resolution, but long range and low light” complementary sensor system does not always have to be installed outside the cabin of the vehicle. Such exterior positioning of the complementary sensor is only necessary for the FIR thermal sensor, which cannot sense through the windshield. For the other optional types of low resolution, long range and low light sensors, the sensors may be disposed inside the vehicle cabin (so as to sense through the windshield of the vehicle and forward of the vehicle) or outside of the vehicle cabin (such as at a forward portion of the vehicle).

The system may utilize aspects of the vision systems described in U.S. patent application publication No. 2016/0119527, and/or U.S. Pat. Nos. 8,764,256; 8,013,780; 7,914,187; 7,720,580 and/or 6,485,081, and/or U.S. Publication No. 2010/0020170, which are hereby incorporated herein by reference in their entireties. The camera or image sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or LIDAR sensors or LADAR sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. Preferably, the forward viewing camera comprises a high resolution camera having at least about 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Publication No. US-2012-0062743, which are hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forward, sideward, or rearward-directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. application publication No. 2006/0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. Nos. 6,690,268 and/or 9,264,672, which are hereby incorporated herein by reference in their entireties. The video mirror display may comprise any suitable devices and systems and optionally may utilize aspects of the display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, which are hereby incorporated herein by reference in their entireties.

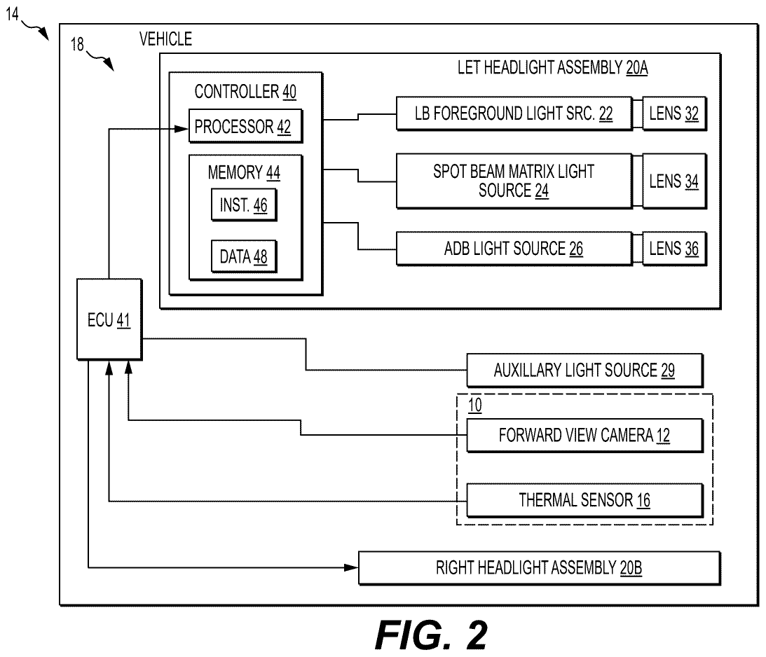

FIG. 2 shows a schematic block diagram of a vehicle 14 with a lighting system 18, according to an aspect of the present disclosure. The vehicle 14 may be a motor vehicle, such as a passenger car or truck. However, the headlamp assembly of the present disclosure may be applicable to other types of vehicles, such as commercial trucks, busses, trains, etc. The vehicle 14 with the lighting system 18 of the present disclosure may also be referred to as the ego vehicle or the subject vehicle. The lighting system 18 includes a left-side headlight assembly 20a and a right-side headlight assembly 20b. Each of the headlight assemblies 20a, 20b may be similar or identical to one-another. In some embodiments, the headlight assemblies 20a, 20b may include similar or identical internal components and different external components, such as a housing that is configured to fit within the structure on the corresponding side of the vehicle 14.

As shown in FIG. 1, each of the headlight assemblies 20a, 20b includes a low-beam foreground light source 22, a spot beam light source 24, and an adaptive driving beam (ADB) light source 26. The foreground light source 22 may also be called a base light source or a foreground base light source and may include one or more light emitting diodes (LEDs), although other types of light sources may be used, such as one or more halogen light bulbs and/or a high-intensity discharge (HID) light source. In some embodiments, the spot beam light source 24 may include at least 20,000 pixel light sources, which may be individually controllable. For example, the spot beam light source 24 may include 248 columns and 82 rows of micro LEDs to provide 20,336 total micro LEDs, each forming a pixel light source. Each of the pixel light sources may include an LED element, although other types of light emitting devices may be used for the pixel light sources. Each of the pixel light sources may have a pixel size of 0.04 mm and a resolution of 0.1°×0.1°. However, the pixel light sources may have a different pixel size and/or a different resolution.

Each of the headlight assemblies 20a, 20b also includes a first lens 32 that is aligned with the low-beam foreground light source 22 to project the light therefrom outwardly in front of the vehicle 14. Each of the headlight assemblies 20a, 20b also includes a second lens 34 that is aligned with the spot beam light source 24 to project the light therefrom outwardly in front of the vehicle 14. Each of the headlight assemblies 20a, 20b also includes a third lens 36 that is aligned with the ADB light source 26 to project the light therefrom outwardly in front of the vehicle 14. In some embodiments, the headlight assemblies 20a, 20b may include a conventional high-beam light source instead of the ADB light source 26. In some embodiments, two or more of the lenses 32, 34, 36 may be combined. For example, a shared lens assembly 32, 36 may function as both the first lens 32 and as the third lens 36 to project light from both the low-beam foreground light source 22 and from the ADB light source 26.

Each of the headlight assemblies 20a, 20b includes a controller 40 in communication with each of the first light source 24, and the the second light source 28. The controller 40 may also be called a headlamp smart lighting driver or a headlamp smart LED driver. The controller 40 may be configured to control patterns of light generated by one or more of the light sources 22, 24, 26. The controller 40 may provide signals to control a brightness level of each of the pixel light sources. For example, the controller 40 may control brightness levels of each of the pixel light sources using on/off signals and with pulse-width modulation (PWM) switching.

The controller 40 includes a processor 42 coupled to a storage memory 44. The storage memory 44 includes instruction storage 46 storing instructions, such as program code for execution by the processor 42. The storage memory 44 also includes data storage 48 for holding data for use by the processor 42.

The vehicle 14 also includes an electronic control unit (ECU) 41, such as a body control module, that is in functional communication with the controllers 40 of each of the the headlight assemblies 20a, 20b and configured to communicate one or more signals for controlling operation of the headlight assemblies. For example, the ECU 41 may direct the headlight assemblies 20a, 20b to operate in a high-beam mode or in a low-beam mode. The ECU 41 may provide additional messages or commands to the controllers 40, such as particular regions to illuminate with a given temperature, color, and/or intensity in order to enhance visibility of a detected object and/or to otherwise visually signal the detected object.

The lighting system 18 shown in FIG. 1 also includes an auxiliary light source 29 that is located outside of the headlight assemblies 20a, 20b. For simplicity of discussion, only one such auxiliary light source 29 is shown. However, the lighting system 18 may include any number of the auxiliary light sources 29. The auxiliary light source 29 may include a fog lamp and/or another light source that may be controlled by the ECU 41. Alternatively or additionally, one or more of the auxiliary light sources 29 may be powered and/or controlled by a controller 40 of a corresponding one of the headlight assemblies 20a, 20b.

As shown, the the forward viewing camera 12 and the thermal sensor 16 of the vision system 10 are each in functional communication with the ECU 41. The ECU 41 may be programmed or otherwise configured to use data from the vision system 10 regarding a sensed object or living being, and to cause the lighting system 18 to enhance a visible luminance of the object or living being and/or a region or surface around the sensed object or living being. For example, the ECU 41 may command one or more of the light sources 22, 24, 26, 29 to change a color, temperature, and/or intensity of light directed toward the sensed object or living being or directed toward a region or surface around the sensed object or living being. In one example, the lighting system 18 may cause the sensed object or living being to be highlighted by a spotlight effect or by increasing illumination of the sensed object or living being or a region of ground or roadway adjacent to or leading toward the sensed object or living being.

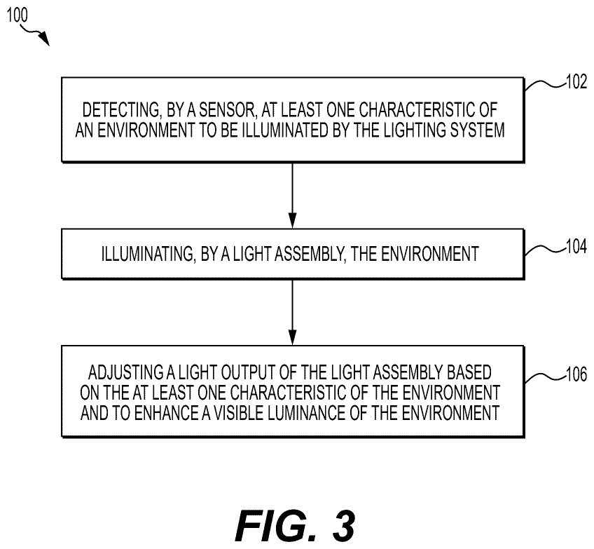

A method 100 for operating a lighting system of a vehicle is shown in the flow chart of FIG. 3. The method 100 can be performed by the lighting system 18 of the present disclosure. As can be appreciated in light of the disclosure, the order of operation within the method is not limited to the sequential execution as illustrated in FIG. 3, but may be performed in one or more varying orders as applicable and in accordance with the present disclosure.

The method 100 includes detecting, at step 102 and by a sensor, at least one characteristic of an environment to be illuminated by the lighting system. For example, the forward viewing camera 12 and/or the thermal sensor 16 may detect one or more characteristics of the environment, such as temperature, presence of an object or living being, and/or reflectance characteristics of the object or living being.

In some embodiments, the sensor may include a thermal sensor, and detecting the at least one characteristic of the environment includes detecting, by the thermal sensor, a hot spot region having an elevated temperature. In some embodiments, the at least one characteristic of the environment may include an object or a living being, and the light output of the light assembly may be adjusted to enhance visible luminance of the object or the living being. In some embodiments, the at least one characteristic of the environment may include an object or a living being, and the light output of the light assembly may be adjusted to enhance illumination of a roadway or other area around the object or the living being. In some embodiments, the sensor may include a camera, and detecting the at least one characteristic of the environment includes detecting, by the camera, an object or a living being. In some embodiments, the at least one characteristic may include a reflectance characteristic of an object or a living being, and adjusting the light output of the light assembly includes adjusting at least one of a temperature or color of the light output based on the reflectance characteristic of the object and to increase a perceived brightness of the object or the living being.

The method 100 also includes illuminating, at step 104 and by a light assembly, the environment. For example, the lighting system 18 may operate one or more one or more of the light sources 22, 24, 26, 29 to be illuminated during normal operation of the vehicle 14, such as while driving at night.

The method 100 also includes adjusting, at step 106, a light output of the light assembly based on the at least one characteristic of the environment and to enhance a visible luminance of the environment. For example, the ECU 41 may command one or more of the light sources 22, 24, 26, 29 to change a color, temperature, and/or intensity of light directed toward the sensed object or living being or directed toward a region or surface around the sensed object or living being.

In some embodiments, adjusting the light output of the light assembly may include adjusting at least one of: a temperature or color output of the light output based on the at least one characteristic of the environment. In some embodiments, adjusting the light output of the light assembly to enhance the visible luminance of the object or the living being further includes increasing an intensity of light directed toward the object or the living being. In some embodiments, adjusting the light output of the light assembly includes adjusting a light output of at least one headlight assembly. In some embodiments, adjusting the light output of the light assembly includes adjusting a light output of an auxiliary light source located not within a headlight assembly.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lighting system for a vehicle, comprising:
a sensor configured to detect at least one characteristic of an environment to be illuminated by the lighting system; and
a light assembly configured to illuminate the environment, wherein the lighting system is configured to adjust a light output of the light assembly based on the at least one characteristic of the environment to enhance a visible luminance of the environment.

2. The lighting system of claim 1, wherein adjusting the light output of the light assembly includes adjusting at least one of a temperature or color output of the light output based on the at least one characteristic of the environment.

3. The lighting system of claim 1, wherein the sensor includes a thermal sensor, and wherein detecting the at least one characteristic of the environment includes detecting, by the thermal sensor, a hot spot region having an elevated temperature.

4. The lighting system of claim 1, wherein the sensor includes a camera, and wherein detecting the at least one characteristic of the environment includes detecting, by the camera, an object or a living being.

5. The lighting system of claim 1, wherein the at least one characteristic of the environment includes an object or a living being, and wherein the light output of the light assembly is adjusted to enhance visible luminance of the object or the living being.

6. The lighting system of claim 5, wherein adjusting the light output of the light assembly to enhance the visible luminance of the object or the living being further includes increasing an intensity of light directed toward the object or the living being.

7. The lighting system of claim 1, wherein the at least one characteristic of the environment includes an object or a living being, and wherein the light output of the light assembly is adjusted to enhance illumination of a roadway or other area around the object or the living being.

8. The lighting system of claim 1, wherein the at least one characteristic includes a reflectance characteristic of an object or a living being, and
wherein adjusting the light output of the light assembly includes adjusting at least one of a temperature or color of the light output based on the reflectance characteristic of the object and to increase a perceived brightness of the object or the living being.

9. The lighting system of claim 1, wherein the light assembly includes at least one headlight assembly, and wherein adjusting the light output of the light assembly includes adjusting a light output of the at least one headlight assembly.

10. The lighting system of claim 1, wherein the light assembly includes at least one auxiliary light source located not within a headlight assembly, and wherein adjusting the light output of the light assembly includes adjusting a light output of the auxiliary light source.

11. A method for operating a lighting system of a vehicle, comprising:
detecting, by a sensor, at least one characteristic of an environment to be illuminated by the lighting system;
illuminating, by a light assembly, the environment; and
adjusting a light output of the light assembly based on the at least one characteristic of the environment and to enhance a visible luminance of the environment.

12. The method of claim 11, wherein adjusting the light output of the light assembly includes adjusting at least one of: a temperature or color output of the light output based on the at least one characteristic of the environment.

13. The method of claim 11, wherein the sensor includes a thermal sensor, and wherein detecting the at least one characteristic of the environment includes detecting, by the thermal sensor, a hot spot region having an elevated temperature.

14. The method of claim 11, wherein the sensor includes a camera, and wherein detecting the at least one characteristic of the environment includes detecting, by the camera, an object or a living being.

15. The method of claim 11, wherein the at least one characteristic of the environment includes an object or a living being, and wherein the light output of the light assembly is adjusted to enhance visible luminance of the object or the living being.

16. The method of claim 15, wherein adjusting the light output of the light assembly to enhance the visible luminance of the object or the living being further includes increasing an intensity of light directed toward the object or the living being.

17. The method of claim 11, wherein the at least one characteristic of the environment includes an object or a living being, and wherein the light output of the light assembly is adjusted to enhance illumination of a roadway or other area around the object or the living being.

18. The method of claim 11, wherein the at least one characteristic includes a reflectance characteristic of an object or a living being, and
wherein adjusting the light output of the light assembly includes adjusting at least one of a temperature or color of the light output based on the reflectance characteristic of the object and to increase a perceived brightness of the object or the living being.

19. The method of claim 11, wherein adjusting the light output of the light assembly includes adjusting a light output of at least one headlight assembly.

20. The method of claim 11, wherein adjusting the light output of the light assembly includes adjusting a light output of an auxiliary light source located not within a headlight assembly.
